(19) United States
(12) Patent Application Publication
(10) Pub. No.: US 2024/0365271 A1
(43) Pub. Date: Oct. 31, 2024

(54) METHOD, APPARATUS AND COMPUTER PROGRAM

(71) Applicant: Nokia Technologies Oy, Espoo (FI)

(72) Inventors: Philippe GODIN, Massy (FR); Anna SILLANPAA, Espoo (FI); Alessio CASATI, WEST MOLESEY (GB); Srinivas BANDI, Bangalore (IN); Rajesh Babu NATARAJAN, Bangalore (IN); Ömer BULAKCI, Munich (DE); Muhammad NASEER-UL-ISLAM, Munich (DE); György Tamás WOLFNER, Budapest (HU)

(21) Appl. No.: 18/577,519

(22) PCT Filed: Jun. 23, 2022
(86) PCT No.: PCT/EP2022/067123

§ 371 Date: Jan. 8, 2024

(30) Foreign Application Priority Data
Jul. 8, 2021 (IN) 202141030697

(51) Int. Cl. H04W 60/04; H04W 48/20

(52) U.S. Cl. CPC H04W 60/04; H04W 48/20

(57) ABSTRACT

There is provided an apparatus for use in a user equipment, wherein the user equipment is operable to be registered in a registration area, the apparatus comprising means configured to perform: providing, to a first network entity, a first message, wherein the first message comprises an indication that the user equipment supports non-uniformly supported network slices in the registration area. The means further configured to perform receiving, from a second network entity, a second message, wherein the second message comprises group mapping information for a tracking area of the registration area, wherein the group mapping information maps the tracking area to at least one group, the at least one group comprising a list of network slices that are non-uniformly supported in the tracking area.

### FIELD

The present application relates to a method, apparatus, and computer program for a wireless communication system.

### BACKGROUND

A communication system may be a facility that enables communication sessions between two or more entities such as user terminals, base stations/access points and/or other nodes by providing carriers between the various entities involved in the communications path. A communication system may be provided, for example, by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

### SUMMARY

According to an aspect, there is provided an apparatus in a user equipment, wherein the user equipment is registered in a registration area, the apparatus comprising means configured to perform: providing, to a first network entity, a first message, wherein the first message comprises an indication that the user equipment supports non-uniformly supported network slices in the registration area; receiving, from a second network entity, a second message, wherein the second message comprises group mapping information for a tracking area of the registration area, wherein the group mapping information maps the tracking area to at least one group, the at least one group comprising a list of network slices that are non-uniformly supported in the tracking area.

In an example, the first and second network entities are the same entity. For example, the first and second network entities are a base station. In another example, the first and second network entities are a 5GC entity. For example, the 5GC entity may be an access management function.

In an example, the first and second network entities are different. For example, the first network entity is a 5GC entity, and the second network entity is a base station. The 5GC entity may be an access management function.

In an example, the second message comprises group mapping information for a tracking area neighbouring the registration area, wherein the group mapping information maps the tracking area to at least one group, the at least one group comprising a list of network slices that are non-uniformly supported in the tracking area.

In an example, the second message comprises further group mapping information for the tracking area neighbouring the registration area, wherein the further group mapping information comprises a further group, the further group comprising a list of network slices that are uniformly supported in the respective tracking area that is neighbouring the registration area.

In an example, the group mapping information and/or the further group mapping information comprises at least one frequency associated with at least one group.

In an example, the means are configured to perform: receiving, from at least one base station serving at least one cell, a broadcast message comprising cell mapping information for: a current tracking area of the at least one cell, wherein the cell mapping information maps a list of cells of the tracking area to the at least one group.

In an example, the broadcast message comprises cell mapping information for a tracking area that neighbours the current tracking area of the at least one cell, wherein the cell mapping information maps a list of cells of the tracking area that neighbours the current tracking area to the at least one group.

In an example, the at least one cell is a current cell where the user equipment is camping.

In an example, the list of cells of the tracking area that neighbours the current tracking area are neighbour cells of a current cell where the user equipment is camping.

In an example, the mapping of the list of cells to the at least one group indicates that the cells in the list of cells support the at least one group. Support of the at least one group meaning that the cells in the list of cells support the network slices comprised in the at least one group.

In an example, the means are configured to perform: determining whether there is at least one cell that neighbours the current cell which supports at least one non-uniformly supported network slice using the received group mapping information and cell mapping information.

In an example, the means are configured to perform: in response to determining that the at least one cell that neighbours the current cell supports at least one non-uniformly supported network slice, selecting the at least one cell that neighbours the current cell during a cell selection or cell reselection process.

In an example, the first message is a non-access stratum registration request message.

In an example, the second message is one of: a non-access stratum registration response message, and a radio resource control release message.

In an example, the list of network slices that are non-uniformly supported in the respective tracking area comprises a list of single-network slice selection assistance information parameters.

In an example, the list of cells of the tracking area comprises a physical cell identification for each cell of the list of cells.

In an example, the at least one group comprises at least two groups, each group of the at least two groups comprising a list of network slices that are non-uniformly supported in the tracking area.

In an example, the cell mapping information comprises, for each group of the at least two groups, a list of cells in the current tracking area that supports the respective group; and/or the cell mapping information comprises, for each group of the at least two groups, a list of cells in the tracking area that neighbours the current tracking area of the at least one cell that supports the respective group.

In an example, the at least one group for the tracking area further comprises: a paging priority level for a paging message.

In an example, the paging priority level for a paging message can also be included in core network assistance information. The core network assistance information may be sent from an AMF to a RAN. This may help the RAN to improve a UE state transition steering and a RAN paging strategy formulation in RRC inactive state.

According to an aspect, there is provided an apparatus comprising: one or more processors, and memory storing instructions that, when executed by the one or more processors, cause the apparatus to perform: providing, to a first network entity, a first message, wherein the first message comprises an indication that the user equipment supports non-uniformly supported network slices in the registration area; receiving, from a second network entity, a second message, wherein the second message comprises group mapping information for a tracking area of the registration area, wherein the group mapping information maps the tracking area to at least one group, the at least one group comprising a list of network slices that are non-uniformly supported in the tracking area.

In an example, the first and second network entities are the same entity. For example, the first and second network entities are a base station. In another example, the first and second network entities are a 5GC entity. For example, the 5GC entity may be an access management function.

In an example, the first and second network entities are different. For example, the first network entity is a 5GC entity, and the second network entity is a base station. The 5GC entity may be an access management function.

In an example, the second message comprises group mapping information for a tracking area neighbouring the registration area, wherein the group mapping information maps the tracking area to at least one group, the at least one group comprising a list of network slices that are non-uniformly supported in the tracking area.

In an example, the second message comprises further group mapping information for the tracking area neighbouring the registration area, wherein the further group mapping information comprises a further group, the further group comprising a list of network slices that are uniformly supported in the respective tracking area that is neighbouring the registration area.

In an example, the group mapping information and/or the further group mapping information comprises at least one frequency associated with at least one group.

In an example, the apparatus is caused to perform: receiving, from at least one base station serving at least one cell, a broadcast message comprising cell mapping information for: a current tracking area of the at least one cell, wherein the cell mapping information maps a list of cells of the tracking area to the at least one group.

In an example, the broadcast message comprises cell mapping information for a tracking area that neighbours the current tracking area of the at least one cell, wherein the cell mapping information maps a list of cells of the tracking area that neighbours the current tracking area to the at least one group.

In an example, the at least one cell is a current cell where the user equipment is camping.

In an example, the list of cells of the tracking area that neighbours the current tracking area are neighbour cells of a current cell where the user equipment is camping.

In an example, the mapping of the list of cells to the at least one group indicates that the cells in the list of cells support the at least one group. Support of the at least one group meaning that the cells in the list of cells support the network slices comprised in the at least one group.

In an example, the apparatus is caused to perform: determining whether there is at least one cell that neighbours the current cell which supports at least one non-uniformly supported network slice using the received group mapping information and cell mapping information.

In an example, the apparatus is caused to perform: in response to determining that the at least one cell that neighbours the current cell supports at least one non-uniformly supported network slice, selecting the at least one cell that neighbours the current cell during a cell selection or cell reselection process.

In an example, the first message is a non-access stratum registration request message.

In an example, the second message is one of: a non-access stratum registration response message, and a radio resource control release message.

In an example, the list of network slices that are non-uniformly supported in the respective tracking area comprises a list of single-network slice selection assistance information parameters.

In an example, the list of cells of the tracking area comprises a physical cell identification for each cell of the list of cells.

In an example, the at least one group comprises at least two groups, each group of the at least two groups comprising a list of network slices that are non-uniformly supported in the tracking area.

In an example, the cell mapping information comprises, for each group of the at least two groups, a list of cells in the current tracking area that supports the respective group; and/or the cell mapping information comprises, for each group of the at least two groups, a list of cells in the tracking area that neighbours the current tracking area of the at least one cell that supports the respective group.

In an example, the at least one group for the tracking area further comprises: a paging priority level for a paging message.

In an example, the paging priority level for a paging message can also be included in core network assistance information. The core network assistance information may be sent from an AMF to a RAN. This may help the RAN to improve a UE state transition steering and a RAN paging strategy formulation in RRC inactive state.

According to an aspect, there is provided a method performed by a user equipment, the method comprising: providing, to a first network entity, a first message, wherein the first message comprises an indication that the user equipment supports non-uniformly supported network slices in the registration area; receiving, from a second network entity, a second message, wherein the second message comprises group mapping information for a tracking area of the registration area, wherein the group mapping information maps the tracking area to at least one group, the at least one group comprising a list of network slices that are non-uniformly supported in the tracking area.

In an example, the first and second network entities are the same entity. For example, the first and second network entities are a base station. In another example, the first and second network entities are a 5GC entity. For example, the 5GC entity may be an access management function.

In an example, the first and second network entities are different. For example, the first network entity is a 5GC entity, and the second network entity is a base station. The 5GC entity may be an access management function.

In an example, the second message comprises group mapping information for a tracking area neighbouring the registration area, wherein the group mapping information maps the tracking area to at least one group, the at least one group comprising a list of network slices that are non-uniformly supported in the tracking area.

In an example, the second message comprises further group mapping information for the tracking area neighbouring the registration area, wherein the further group mapping information comprises a further group, the further group comprising a list of network slices that are uniformly supported in the respective tracking area that is neighbouring the registration area.

In an example, the method comprises: receiving, from at least one base station serving at least one cell, a broadcast message comprising cell mapping information for: a current tracking area of the at least one cell, wherein the cell mapping information maps a list of cells of the tracking area to the at least one group.

In an example, the broadcast message comprises cell mapping information for a tracking area that neighbours the current tracking area of the at least one cell, wherein the cell mapping information maps a list of cells of the tracking area that neighbours the current tracking area to the at least one group.

In an example, the at least one cell is a current cell where the user equipment is camping.

In an example, the list of cells of the tracking area that neighbours the current tracking area are neighbour cells of a current cell where the user equipment is camping.

In an example, the mapping of the list of cells to the at least one group indicates that the cells in the list of cells support the at least one group. Support of the at least one group meaning that the cells in the list of cells support the network slices comprised in the at least one group.

In an example, the method comprises: determining whether there is at least one cell that neighbours the current cell which supports at least one non-uniformly supported network slice using the received group mapping information and cell mapping information.

In an example, the method comprises: in response to determining that the at least one cell that neighbours the current cell supports at least one non-uniformly supported network slice, selecting the at least one cell that neighbours the current cell during a cell selection or cell reselection process.

In an example, the first message is a non-access stratum registration request message.

In an example, the second message is one of: a non-access stratum registration response message, and a radio resource control release message.

In an example, the list of network slices that are non-uniformly supported in the respective tracking area comprises a list of single-network slice selection assistance information parameters.

In an example, the list of cells of the tracking area comprises a physical cell identification for each cell of the list of cells.

In an example, the at least one group comprises at least two groups, each group of the at least two groups comprising a list of network slices that are non-uniformly supported in the tracking area.

In an example, the cell mapping information comprises, for each group of the at least two groups, a list of cells in the current tracking area that supports the respective group; and/or the cell mapping information comprises, for each group of the at least two groups, a list of cells in the tracking area that neighbours the current tracking area of the at least one cell that supports the respective group.

In an example, the at least one group for the tracking area further comprises: a paging priority level for a paging message.

In an example, the paging priority level for a paging message can also be included in core network assistance information. The core network assistance information may be sent from an AMF to a RAN. This may help the RAN to improve a UE state transition steering and a RAN paging strategy formulation in RRC inactive state.

According to an aspect, there is provided an apparatus in a cellular system, the apparatus comprising means configured to perform: receiving, from a user equipment, a first message, wherein the first message comprises an indication that the user equipment supports non-uniformly supported network slices in a registration area; providing a second message, wherein the second message comprises group mapping information per tracking area of the registration area of the user equipment, wherein the group mapping information comprises at least one group, the at least one group comprising a list of network slices that are non-uniformly supported in the respective tracking area.

In an example, the second message is provided to one of: the user equipment, and a base station.

In an example, the second message comprises group mapping information for a tracking area neighbouring the registration area, wherein the group mapping information maps the tracking area to at least one group, the at least one group comprising a list of network slices that are non-uniformly supported in the tracking area.

In an example, the second message comprises further group mapping information for the tracking area neighbouring the registration area, wherein the further group mapping information comprises a further group, the further group comprising a list of network slices that are uniformly supported in the respective tracking area that is neighbouring the registration area.

In an example, the first message is a non-access stratum registration request message.

In an example, the second message is a non-access stratum registration response message.

In an example, the list of network slices that are non-uniformly supported in the respective tracking area comprises a list of single-network slice selection assistance information parameters.

In an example, the at least one group comprises at least two groups, each group of the at least two groups comprising a list of network slices that are non-uniformly supported in the tracking area.

In an example, the at least one group for the tracking area further comprises: a paging priority level for a paging message.

In an example, the means are configured to perform: configuring the group mapping information per tracking area of the registration area.

In an example, the means are configured to perform: receiving the group mapping information per tracking area of the registration area.

In an example, the means configured to perform receiving the group mapping information comprises: receiving, from at least one base station, a third message comprising: group mapping information per tracking area of the at least one base station, the group mapping information comprising at least one group, wherein the at least one group comprises a list of network slices that are not supported in all cells of the respective tracking area.

In an example, the third message comprises: further group mapping information per tracking area that neighbours the tracking area of the at least one base station, the further group mapping information comprising: a single group, wherein the single group comprises a list of network slices that are uniformly supported in the respective tracking area; and at least one further group, wherein the at least one further group comprises a list of network slices that are not supported in all cells of the respective tracking area.

In an example, the means are configured to perform: when the at least one base station comprises at least two base stations, consolidating, at an access and mobility function of the apparatus, the information received in third message from the at least two base stations to configure the second message.

According to an aspect, there is provided an apparatus comprising: one or more processors, and memory storing instructions that, when executed by the one or more processors, cause the apparatus to perform: receiving, from a user equipment, a first message, wherein the first message comprises an indication that the user equipment supports non-uniformly supported network slices in a registration area; providing a second message, wherein the second message comprises group mapping information per tracking area of the registration area of the user equipment, wherein the group mapping information comprises at least one group, the at least one group comprising a list of network slices that are non-uniformly supported in the respective tracking area.

In an example, the second message is provided to one of: the user equipment, and a base station.

In an example, the second message comprises group mapping information for a tracking area neighbouring the registration area, wherein the group mapping information maps the tracking area to at least one group, the at least one group comprising a list of network slices that are non-uniformly supported in the tracking area.

In an example, the second message comprises further group mapping information for the tracking area neighbouring the registration area, wherein the further group mapping information comprises a further group, the further group comprising a list of network slices that are uniformly supported in the respective tracking area that is neighbouring the registration area.

In an example, the first message is a non-access stratum registration request message.

In an example, the second message is a non-access stratum registration response message.

In an example, the list of network slices that are non-uniformly supported in the respective tracking area comprises a list of single-network slice selection assistance information parameters.

In an example, the at least one group comprises at least two groups, each group of the at least two groups comprising a list of network slices that are non-uniformly supported in the tracking area.

In an example, the at least one group for the tracking area further comprises: a paging priority level for a paging message.

In an example, the apparatus is caused to perform: configuring the group mapping information per tracking area of the registration area.

In an example, the apparatus is caused to perform: receiving the group mapping information per tracking area of the registration area.

In an example, the apparatus is caused to perform: receiving the group mapping information comprises: receiving, from at least one base station, a third message comprising: group mapping information per tracking area of the at least one base station, the group mapping information comprising at least one group, wherein the at least one group comprises a list of network slices that are not supported in all cells of the respective tracking area.

In an example, the third message comprises: further group mapping information per tracking area that neighbours the tracking area of the at least one base station, the further group mapping information comprising: a single group, wherein the single group comprises a list of network slices that are uniformly supported in the respective tracking area; and at least one further group, wherein the at least one further group comprises a list of network slices that are not supported in all cells of the respective tracking area.

In an example, the apparatus is caused to perform: when the at least one base station comprises at least two base stations, consolidating, at an access and mobility function of the apparatus, the information received in third message from the at least two base stations to configure the second message.

According to an aspect, there is provided a method performed by an apparatus of a cellular system, the method comprising: receiving, from a user equipment, a first message, wherein the first message comprises an indication that the user equipment supports non-uniformly supported network slices in a registration area; providing a second message, wherein the second message comprises group mapping information per tracking area of the registration area of the user equipment, wherein the group mapping information comprises at least one group, the at least one group comprising a list of network slices that are non-uniformly supported in the respective tracking area.

In an example, the second message is provided to one of: the user equipment, and a base station.

In an example, the second message comprises group mapping information for a tracking area neighbouring the registration area, wherein the group mapping information maps the tracking area to at least one group, the at least one group comprising a list of network slices that are non-uniformly supported in the tracking area.

In an example, the second message comprises further group mapping information for the tracking area neighbouring the registration area, wherein the further group mapping information comprises a further group, the further group comprising a list of network slices that are uniformly supported in the respective tracking area that is neighbouring the registration area.

In an example, the first message is a non-access stratum registration request message.

In an example, the second message is a non-access stratum registration response message.

In an example, the list of network slices that are non-uniformly supported in the respective tracking area comprises a list of single-network slice selection assistance information parameters.

In an example, the at least one group comprises at least two groups, each group of the at least two groups comprising a list of network slices that are non-uniformly supported in the tracking area.

In an example, the at least one group for the tracking area further comprises: a paging priority level for a paging message.

In an example, the method comprises: configuring the group mapping information per tracking area of the registration area.

In an example, the method comprises: receiving the group mapping information per tracking area of the registration area.

In an example, the method comprises: receiving the group mapping information comprises: receiving, from at least one base station, a third message comprising: group mapping information per tracking area of the at least one base station, the group mapping information comprising at least one group, wherein the at least one group comprises a list of network slices that are not supported in all cells of the respective tracking area.

In an example, the third message comprises: further group mapping information per tracking area that neighbours the tracking area of the at least one base station, the further group mapping information comprising: a single group, wherein the single group comprises a list of network slices that are uniformly supported in the respective tracking area; and at least one further group, wherein the at least one further group comprises a list of network slices that are not supported in all cells of the respective tracking area.

In an example, the method comprises: when the at least one base station comprises at least two base stations, consolidating, at an access and mobility function of the apparatus, the information received in third message from the at least two base stations to configure the second message.

According to an aspect, there is provided an apparatus in a base station, the base station serving at least one cell, wherein the base station is located in a registration area, the apparatus comprising means configured to perform: providing, to a user equipment, a second message, wherein the second message comprises group mapping information for a tracking area of the registration area of the user equipment, wherein the group mapping information maps the tracking area to at least one group, the at least one group comprising a list of network slices that are non-uniformly supported in the tracking area.

In an example, the second message comprises group mapping information for a tracking area neighbouring the registration area of the user equipment, wherein the group mapping information maps the tracking area to at least one group, the at least one group comprising a list of network slices that are non-uniformly supported in the tracking area.

In an example, the second message comprises further group mapping information for the tracking area neighbouring the registration area, wherein the further group mapping information comprises a further group, the further group comprising a list of network slices that are uniformly supported in the respective tracking area that is neighbouring the registration area.

In an example, the means are configured to perform: providing, to the user equipment, a broadcast message comprising cell mapping information for: a current tracking area of the at least one cell, wherein the cell mapping information maps a list of cells of the tracking area to the at least one group.

In an example, the broadcast message comprises cell mapping information for a tracking area that neighbours the current tracking area of the at least one cell, wherein the cell mapping information maps a list of cells of the tracking area that neighbours the current tracking area to the at least one group.

In an example, the at least one cell is a current cell where the user equipment is camping.

In an example, the list of cells of the tracking area that neighbours the current tracking area are neighbour cells of the current cell

In an example, the second message is a radio resource control release message.

In an example, the list of network slices that are non-uniformly supported in the respective tracking area comprises a list of single-network slice selection assistance information parameters.

In an example, the list of cells of the tracking area comprises a physical cell identification for each cell of the list of cells.

In an example, the at least one group comprises at least two groups, each group of the at least two groups comprising a list of network slices that are non-uniformly supported in the tracking area.

In an example, the cell mapping information comprises, for each group of the at least two groups, a list of cells in the current tracking area that supports the respective group; and/or the cell mapping information comprises, for each group of the at least two groups, a list of cells in the tracking area that neighbours the current tracking area of the at least one cell that supports the respective group.

In an example, the at least one group for the tracking area further comprises:

a paging priority level for a paging message.

In an example, the means are configured to perform: configuring the group mapping information per tracking area of the base station.

In an example, the means are configured to perform: in response to configuring the group mapping information per tracking area of the base station, providing the group mapping information to an access management function of a cellular system in a next generation setup message.

In an example, the means are configured to perform: receiving the group mapping information per tracking area of the registration area.

In an example, the group mapping information is received from an access management function of a cellular system in a next generation application protocol initial context setup request message.

In an example, the means are configured to perform: storing the received group mapping information in a user equipment context for the user equipment.

In an example, the means are configured to perform: providing the stored user equipment context comprising the group mapping information to a further base station during a handover procedure.

According to an aspect, there is provided an apparatus comprising: one or more processors, and memory storing instructions that, when executed by the one or more processors, cause the apparatus to perform: providing, to a user equipment, a second message, wherein the second message comprises group mapping information for a tracking area of the registration area of the user equipment, wherein the group mapping information maps the tracking area to at least one group, the at least one group comprising a list of network slices that are non-uniformly supported in the tracking area.

In an example, the second message comprises group mapping information for a tracking area neighbouring the registration area of the user equipment, wherein the group mapping information maps the tracking area to at least one group, the at least one group comprising a list of network slices that are non-uniformly supported in the tracking area.

In an example, the second message comprises further group mapping information for the tracking area neighbouring the registration area, wherein the further group mapping information comprises a further group, the further group comprising a list of network slices that are uniformly supported in the respective tracking area that is neighbouring the registration area.

In an example, the apparatus is caused to perform: providing, to the user equipment, a broadcast message comprising cell mapping information for: a current tracking area of the at least one cell, wherein the cell mapping information maps a list of cells of the tracking area to the at least one group.

In an example, the broadcast message comprises cell mapping information for a tracking area that neighbours the current tracking area of the at least one cell, wherein the cell mapping information maps a list of cells of the tracking area that neighbours the current tracking area to the at least one group.

In an example, the at least one cell is a current cell where the user equipment is camping.

In an example, the list of cells of the tracking area that neighbours the current tracking area are neighbour cells of the current cell

In an example, the second message is a radio resource control release message.

In an example, the list of network slices that are non-uniformly supported in the respective tracking area comprises a list of single-network slice selection assistance information parameters.

In an example, the list of cells of the tracking area comprises a physical cell identification for each cell of the list of cells.

In an example, the at least one group comprises at least two groups, each group of the at least two groups comprising a list of network slices that are non-uniformly supported in the tracking area.

In an example, the cell mapping information comprises, for each group of the at least two groups, a list of cells in the current tracking area that supports the respective group; and/or the cell mapping information comprises, for each group of the at least two groups, a list of cells in the tracking area that neighbours the current tracking area of the at least one cell that supports the respective group.

In an example, the at least one group for the tracking area further comprises: a paging priority level for a paging message.

In an example, the apparatus is caused to perform: configuring the group mapping information per tracking area of the base station.

In an example, the apparatus is caused to perform: in response to configuring the group mapping information per tracking area of the base station, providing the group mapping information to an access management function of a cellular system in a next generation setup message.

In an example, the apparatus is caused to perform: receiving the group mapping information per tracking area of the registration area.

In an example, the group mapping information is received from an access management function of a cellular system in a next generation application protocol initial context setup request message.

In an example, the apparatus is caused to perform: storing the received group mapping information in a user equipment context for the user equipment.

In an example, the apparatus is caused to perform: providing the stored user equipment context comprising the group mapping information to a further base station during a handover procedure.

According to an aspect, there is provided a method performed by a base station, the base station serving at least one cell, wherein the base station is located in a registration area, the method comprising: providing, to a user equipment, a second message, wherein the second message comprises group mapping information for a tracking area of the registration area of the user equipment, wherein the group mapping information maps the tracking area to at least one group, the at least one group comprising a list of network slices that are non-uniformly supported in the tracking area.

In an example, the second message comprises group mapping information for a tracking area neighbouring the registration area of the user equipment, wherein the group mapping information maps the tracking area to at least one group, the at least one group comprising a list of network slices that are non-uniformly supported in the tracking area.

In an example, the second message comprises further group mapping information for the tracking area neighbouring the registration area, wherein the further group mapping information comprises a further group, the further group comprising a list of network slices that are uniformly supported in the respective tracking area that is neighbouring the registration area.

In an example, the method comprises: providing, to the user equipment, a broadcast message comprising cell mapping information for: a current tracking area of the at least one cell, wherein the cell mapping information maps a list of cells of the tracking area to the at least one group.

In an example, the broadcast message comprises cell mapping information for a tracking area that neighbours the current tracking area of the at least one cell, wherein the cell mapping information maps a list of cells of the tracking area that neighbours the current tracking area to the at least one group.

In an example, the at least one cell is a current cell where the user equipment is camping.

In an example, the list of cells of the tracking area that neighbours the current tracking area are neighbour cells of the current cell

In an example, the second message is a radio resource control release message.

In an example, the list of network slices that are non-uniformly supported in the respective tracking area comprises a list of single-network slice selection assistance information parameters.

In an example, the list of cells of the tracking area comprises a physical cell identification for each cell of the list of cells.

In an example, the at least one group comprises at least two groups, each group of the at least two groups comprising a list of network slices that are non-uniformly supported in the tracking area.

In an example, the cell mapping information comprises, for each group of the at least two groups, a list of cells in the current tracking area that supports the respective group; and/or the cell mapping information comprises, for each group of the at least two groups, a list of cells in the tracking area that neighbours the current tracking area of the at least one cell that supports the respective group.

In an example, the at least one group for the tracking area further comprises: a paging priority level for a paging message.

In an example, the method comprises: configuring the group mapping information per tracking area of the base station.

In an example, the method comprises: in response to configuring the group mapping information per tracking area of the base station, providing the group mapping information to an access management function of a cellular system in a next generation setup message.

In an example, the method comprises: receiving the group mapping information per tracking area of the registration area.

In an example, the group mapping information is received from an access management function of a cellular system in a next generation application protocol initial context setup request message.

In an example, the method comprises: storing the received group mapping information in a user equipment context for the user equipment.

In an example, the method comprises: providing the stored user equipment context comprising the group mapping information to a further base station during a handover procedure.

According to an aspect, there is provided a computer program comprising computer executable instructions which when run on one or more processors perform: providing, to a first network entity, a first message, wherein the first message comprises an indication that the user equipment supports non-uniformly supported network slices in the registration area; receiving, from a second network entity, a second message, wherein the second message comprises group mapping information for a tracking area of the registration area, wherein the group mapping information maps the tracking area to at least one group, the at least one group comprising a list of network slices that are non-uniformly supported in the tracking area.

According to an aspect, there is provided a computer program comprising computer executable instructions which when run on one or more processors perform: receiving, from a user equipment, a first message, wherein the first message comprises an indication that the user equipment supports non-uniformly supported network slices in a registration area; providing a second message, wherein the second message comprises group mapping information per tracking area of the registration area of the user equipment, wherein the group mapping information comprises at least one group, the at least one group comprising a list of network slices that are non-uniformly supported in the respective tracking area.

According to an aspect, there is provided a computer program comprising computer executable instructions which when run on one or more processors perform:: providing, to a user equipment, a second message, wherein the second message comprises group mapping information for a tracking area of the registration area of the user equipment, wherein the group mapping information maps the tracking area to at least one group, the at least one group comprising a list of network slices that are non-uniformly supported in the tracking area.

A computer product stored on a medium may cause an apparatus to perform the methods as described herein.

An electronic device may comprise apparatus as described herein.

In the above, various aspects have been described. It should be appreciated that further aspects may be provided by the combination of any two or more of the various aspects described above.

Various other aspects and further embodiments are also described in the following detailed description and in the attached claims.

According to some aspects, there is provided the subject matter of the independent claims. Some further aspects are defined in the dependent claims. The embodiments that do not fall under the scope of the claims are to be interpreted as examples useful for understanding the disclosure.

### List of Abbreviations

AF: Application Function
AMF: Access Management Function
AN: Access Network
BS: Base Station
CN: Core Network
DL: Downlink
eNB: eNodeB
gNB: gNodeB
IIoT: Industrial Internet of Things
LTE: Long Term Evolution
NEF: Network Exposure Function
NG-RAN: Next Generation Radio Access Network
NGAP: Next Generation Application Protocol
NF: Network Function
NR: New Radio
NRF: Network Repository Function
NW: Network
MS: Mobile Station
PCF Policy Control Function
PCI: Physical Cell Identity
PLMN: Public Land Mobile Network
RA: Registration Area
RAN: Radio Access Network
RF: Radio Frequency
SMF: Session Management Function
S-NSSAI: Single-Network Slice Selection Assistance Information
TA: Tracking Area
UE: User Equipment
UDR: Unified Data Repository
UDM: Unified Data Management
UL Uplink
UPF: User Plane Function
3GPP: 3rd Generation Partnership Project
5G 5th Generation
5GC: 5G Core network
5G-AN: 5G Radio Access Network
5GS: 5G System

### DESCRIPTION OF FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4 shows a schematic representation of the format of S-NSSAI;

FIG. 5 shows an example signalling diagram between a user equipment and network entities;

FIG. 6 shows an example signalling diagram between a user equipment and network entities;

FIG. 7 shows an example signalling diagram between network entities;

FIG. 8 shows another example signalling diagram between network entities;

FIG. 9 shows an example method flow diagram performed by a user equipment

FIG. 10 shows an example method flow diagram performed by an apparatus of a cellular system;

FIG. 11 shows an example method flow diagram performed by a base station; and

FIG. 12 shows a schematic representation of a non-volatile memory medium storing instructions which when executed by a processor allow a processor to perform one or more of the steps of the method of FIGS. 9 to 11.

### DETAILED DESCRIPTION

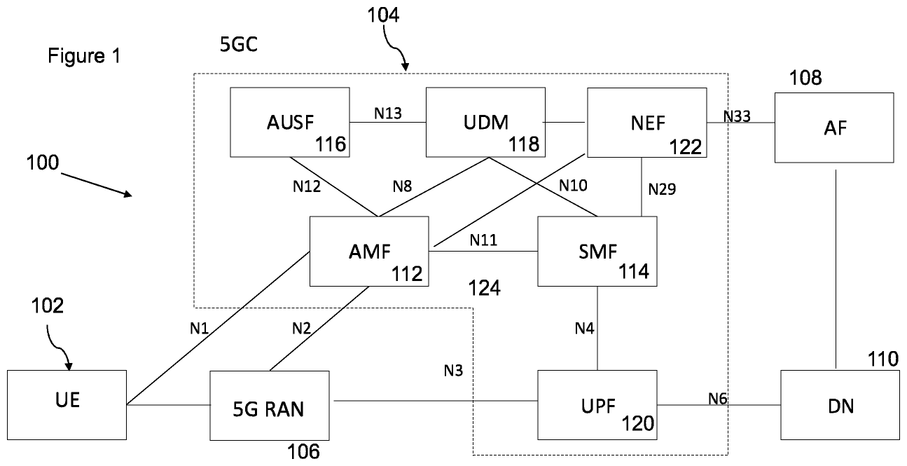

Before explaining in detail some examples of the present disclosure, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices/terminals or user apparatuses, and/or user equipments (UE), and/or machine-type communication devices 102 are provided wireless access via at least one base station (not shown) or similar wireless transmitting and/or receiving node or point. A communication device is provided with an appropriate signal receiving and transmitting apparatus for enabling communications, for example enabling access to a communication network or communications directly with other devices. The communication device may access a carrier provided by a station or access point, and transmit and/or receive communications on the carrier.

In the following certain examples are explained with reference to mobile communication devices capable of communication via a wireless cellular system and mobile communication systems serving such mobile communication devices. Before explaining in detail the examples of disclose, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS) 100. The 5GS may comprises a device 102 such as user equipment or terminal, a 5G access network (5G-AN) 106, a 5G core network (5GC) 104, one or more network functions (NF), one or more application function (AF) 108 and one or more data networks (DN) 110.

The 5G-AN 106 may comprise one or more gNodeB (gNB) distributed unit functions connected to one or more gNodeB (gNB) centralized unit functions.

The 5GC 104 may comprise an access management function (AMF) 112, a session management function (SMF) 114, an authentication server function (AUSF) 116, a user data management (UDM) 118, a user plane function (UPF) 120, a network exposure function (NEF) 122 and/or other NFs. Some of the examples as shown below may be applicable to 3GPP 5G standards. However, some examples may also be applicable to 4G, 3G and other 3GPP standards.

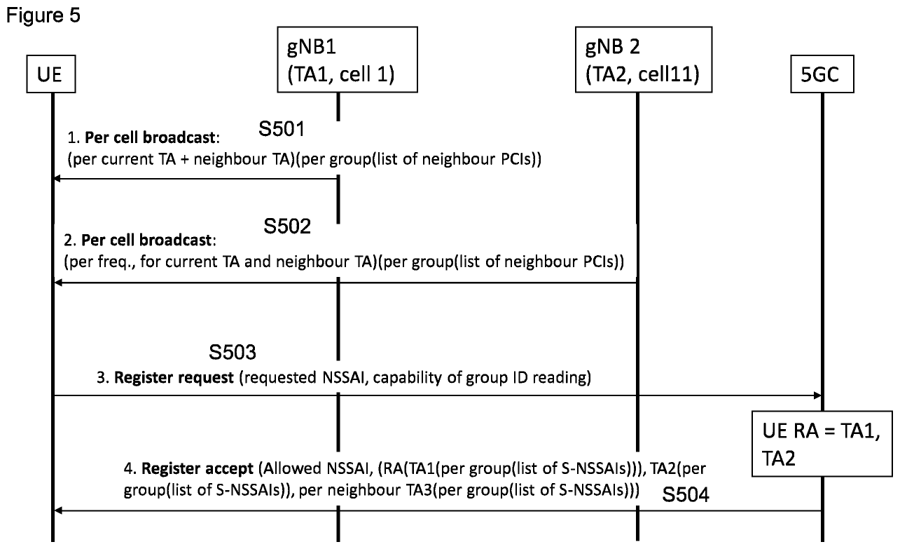

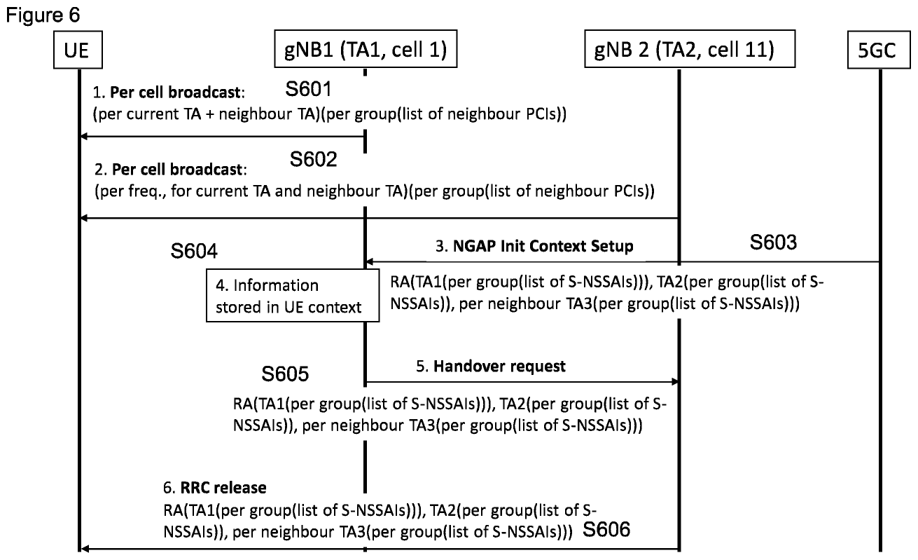

In a communication system, such as that shown in FIG. 1, mobile communication devices/terminals or user apparatuses, and/or user equipments (UE), and/or machine-type communication devices are provided with wireless access via at least one base station or similar wireless transmitting and/or receiving node or point. The terminal is provided with an appropriate signal receiving and transmitting apparatus for enabling communications, for example enabling access to a communication network or communications directly with other devices. The communication device may access a carrier provided by a station or access point, and transmit and/or receive communications on the carrier. Terminal 102 is also depicted in FIG. 5, with labels 10, 16, 19, 20A, 20B. Terminal 102 is also depicted in FIG. 6 with label 601, for example. The terminal 102 may use communications services. Two or more terminals may use the same communications services. In other examples, two or more terminals may have different services from each other.

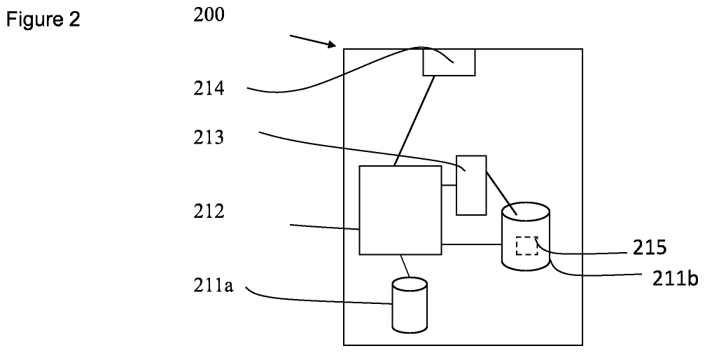

FIG. 2 illustrates an example of a control apparatus 200 for controlling a function of the 5G-AN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G-AN or the 5GC. In some examples, each function of the 5G-AN or the 5GC comprises a control apparatus 200. In alternative examples, two or more functions of the 5G-AN or the 5GC may share a control apparatus.

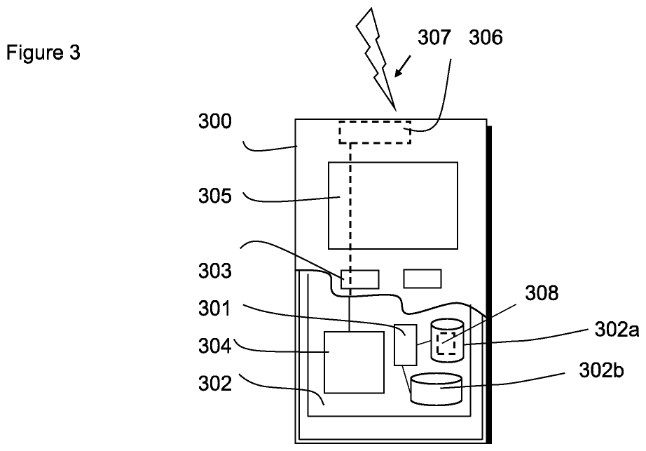

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302a and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus may be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

Some of the following examples are relevant to 5G. Network slicing is a key 5G feature which allows support for different services using the same underlying mobile network infrastructure. Network slices can differ either in their service requirements like, for example, Ultra-Reliable Low Latency Communication (URLLC) and enhanced Mobile Broadband (eMBB) or the architecture that provides those services.

A network slice is identified via a single-network slice selection assistance information (S-NSSAI). In some example specifications, a user equipment can be simultaneously connected and served by a maximum of eight S-NSSAIs. On other hand, a cell may support tens or hundreds of S-NSSAIs. For example, in some specifications, a tracking area can have a support up to 1024 network slices.

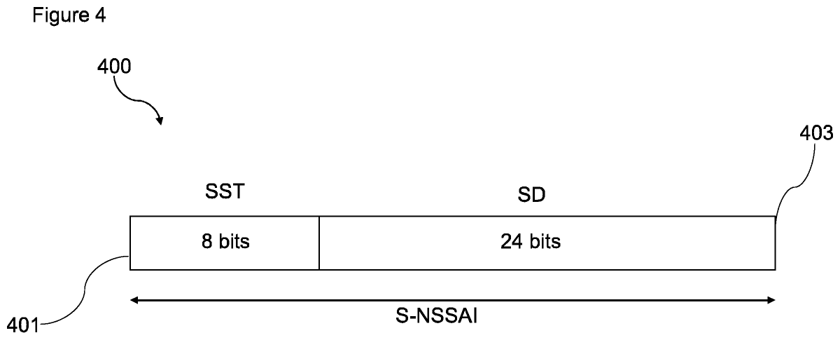

FIG. 4 shows a schematic representation of the format of S-NSSAI. The S-NSSAI 400 includes both a slice service type (SST) 401 and a slice differentiator (SD) field 403. The S-NSSAI 400 may have a total length of 32 bits. Alternatively, the S-NSSAI may include only SST field 401 part in which case the length of S-NSSAI 400 is 8 bits. The SST field 401 may have standardized and non-standardized values. Values 0 to 127 may belong to the standardized SST range. For instance, SST value of 1 may indicate that the slice is suitable for handling of 5G eMBB, 2 for handling of URLLC, etc. The SD field 403 is operator-defined.

In a wireless network, cells are grouped together into TAs. One or more TAs may then be assigned to the UE as an RA. The RA is used as a base for the network to search for the UE and for the UE to report its location.

The concept allows a UE to belong to a list of different TAs. Different UEs can be allocated to different lists of TAs. If the UE moves within its list of allocated TAs, it does not have to perform a tracking area update. By allocating different lists of tracking areas to different UEs, the operator can give UEs different registration area borders and so reduce peaks in registration update signalling, for example when a train passes a TA border.

In current specifications, there is homogeneous support for network slices throughout the TAs of an RA. The homogenous support means that each TA within the RA supports the same network slices. This means there is uniform support for a list of network slices (S-NSSAIs) throughout an RA. In current specifications, a UE will receive signalling such that the UE is aware of all uniformly supported network slices within the RA.

It has been identified that it is desirable to configure additional network slices in ‘hot spots’ or other specific areas. The additional network slices may not be supported throughout the whole TA. Therefore the additional network slices may not be supported throughout the RA also. In this way, the additional network slices are non-uniformly supported network slices. It may be desirable to configure these additional network slices in a specific area due to, for example, a large sporting event, or a music concert. The concentrated amount of people moving to a relatively small area may put a strain on the network. The additional network slices for area may reduce said strain. The additional network slices may be temporarily supported in the area. In this way, one or more cells of a TA will support (possibly temporarily) additional network slices compared to the basic set of slices homogeneously/uniformly supported in the TA.

There is a need to inform the user equipments of the non-uniformly supported network slices without redefining the whole TA, or adding TAs. It had been proposed to broadcast, in those cells with the additional network slice support, these additional slices to the UEs. However, each slice comprises 32 octets and so this option is not scalable. This would use excessive network resources. It had also been proposed to define an index for each combination of network slice support throughout the RA, wherein each index refers to a pre-defined list of network slices which is unique throughout the PLMN. However, the number of combination of N slices in a PLMN where N can have multiple values is an exponential combinatory. In this way, excessive network resources would be used. One or more of the examples below aims to address one or more of the problems identified above.

In some examples, there is provided group mapping information to a user equipment. The group mapping information is provided per tracking area. The group mapping information maps a respective tracking area to one or more groups, wherein the one or more groups comprise a list of network slices that are non-uniformly supported in the respective tracking area. This will be described in more detail below.

FIG. 5 shows an example signalling diagram between a user equipment and network entities. In FIG. 5, there are communications between a UE, a first and second base station (gNB1, gNB2), and a 5G core network (5GC). In this example, the UE has been allocated to both TA1 and TA2, which are part of the same RA (UE RA=TA1, TA2). In this example, the UE may be currently camping on gNB1 (cell 1).

In the example of FIG. 5, the UE indicates its support for the group mapping information per tracking area mechanism. This is referred to as a ‘group reading capability’. The UE provides this indication of support to the 5GC in a first message. The first message may be a non-access stratum (NAS) register request. When the 5GC detects this indication from the UE, the 5GC sends a second message to the UE. The second message comprises the allowed NSSAI (uniformly supported network slices) and additionally for one or more i) TAs of the RA of the UE and ii) the TAs neighbouring the RA: a group mapping information for each TA. The second message may be an NAS register accept message. The group mapping information for each TA may have been earlier received, at the 5GC, from one or more gNBs. The group mapping information may alternatively have been configured by operation and maintenance (O&M) at the 5GC. For a tracking area, each group indicates a unique combination of network slices that are supported in the TA by one or more cells. If a network slice is supported by all cells of the TA then this is referred to as uniform support. If a network slice is supported by some but not all cells of the TA, then this is referred to as non-uniform support). For example, there may be four different groups for a particular TA because the cells of the TA support 4 different combinations of network slices.

In the second message, the 5GC sends to the UE:
For each TA of the RA: one or more groups (wherein each group is list of S-NSSAIs non uniformly supported in the TA)
For each TA neighbouring the RA: one or more groups (wherein each group is a list of S-NSSAIs non-uniformly supported in the TA)+one further group of S-NSSAIs that are uniformly supported in the TA.
   For the TAs that neighbour the RA of the UE, the further group is provided because the UE does not know which network slices are uniformly supported in a TA that does not belong to said UE's RA.

It should be understood, that in some examples, not all of the TAs in the RA will provide the group mapping information. In these examples, a subset of the TAs in the RA will provide group mapping information.

Additionally, one or more gNBs provide a cell broadcast. The cell broadcast provides cell mapping information for a current tracking area and/or a neighbour tracking area. The cell mapping information maps a list of cells to the one or more groups. The cells may be identified by a physical cell identity (PCI). The mapping shows which cells support the combination of non-uniformly supported network slices, as identified in each group.

In the cell broadcast, the gNB sends to the UE:
per current TA, per group (list of neighbour cell PCIs that support the group))
per neighbour TA, per group (list of neighbour cell PCIs that support the group)

In some examples, a gNB may also provide the information on a per frequency basis. This may occur, if for example, some of neighbour cells of the current cell are transmitting on a different frequency compared to current cell.
(per frequency, for current TA+neighbour TA) (per group (list of neighbour PCIs that support the group))

When the UE has received the signalling, the UE may use the group mapping information for all TAs, and the cell mapping information broadcast in its current cell, to identify which are the network slices that are supported by each neighbour cell identified by a PCI. The UE can use this to influence its cell selection/cell re-selection process.

In S501, a first base station (gNB1) provides a cell broadcast. The gNB1 may represent a first cell (cell 1), which is part of a first TA (TA1). The cell broadcast may comprise cell mapping information for TA1. The cell mapping information maps a list of cells of TA1 to one or more groups. Each group comprises a list of network slices that are non-uniformly supported in TA1.

The cell broadcast may also comprise cell mapping information for a TA that neighbours TA1. For example, TA2 may neighbour TA1. The cell mapping information maps a list of cells of TA2 to one or more groups. Each group comprises a list of network slices that are non-uniformly supported in TA2.

As an example only to aid understanding, gNB1 may provide to the user equipment (broadcast from cell 1):
TA1: [Group 1 (supported by cells 2, 3), Group 2 (supported by cells 5,7)]
TA2: [Group 1 (supported by cells 14, 15), Group 2 (supported by cells 16, 17)]

This broadcast indicates that cells 2 and 3 support the non-uniformly supported network slices comprised within group 1 of TA1. Furthermore, that cells 5 and 7 support the non-uniformly supported network slices comprised within group 2 of TA1. This broadcast also indicates that cells 14 and 15 support the non-uniformly supported network slices comprised within group 1 of TA2. Furthermore, that cells 16 and 17 support the non-uniformly supported network slices comprised within group 2 of TA2. In the above example, cells 1-9 may be part of TA1, while cells 10-19 may be part of TA2. It should be understood, that as the groups are uniquely associated with each TA, the network slices supported in group 1 of TA1 and group 1 of TA2 may be different.

At S502, a second base station (gNB2) provides a cell broadcast. The gNB2 may represent a second cell (cell 11), which is part of a second TA (TA2). The cell broadcast may comprise cell mapping information for TA2. The cell mapping information maps a list of cells of TA2 to one or more groups. Each group comprises a list of network slices that are non-uniformly supported in TA2.

The cell broadcast may also comprise cell mapping information for a TA that neighbours TA2. For example, TA1 neighbours TA2. The cell mapping information maps a list of cells of TA1 to one or more groups. Each group comprises a list of network slices that are non-uniformly supported in TA1.

In some examples, at S502, the gNB2 provide the cell mapping information on a per frequency basis. This may occur, if for example, some neighbour cells of the current cell are transmitting on a different frequency compared to the current cell.

In S503, the UE provides a first message to the 5GC. The first message may be provided to the 5GC via gNB1. In some examples, the first message is a register request message. For example, an NAS register request message. In other examples, other suitable message types may be used.

The first message may comprise an indication that the UE supports non-uniformly supported network slices in the registration area. The first message may also comprise a request for a network slice to be used by the UE.

In S504, the 5GC provides a second message to the UE. The second message may be provided to the UE via gNB1. In some examples, the second message is a register accept message. For example, an NAS register accept message. In other examples, other suitable message types may be used.

The second message may comprise an allowed network slice. The allowed network slice may be identified by a list of one or more S-NSSAIs.

The second message may comprise group mapping information for a TA1 of the RA. The group mapping information maps TA1 to one or more groups, the one or more groups comprising a list of network slices that are non-uniformly supported in TA1. Group mapping information may be provided for other TAs within the RA.

The second message may also comprise group mapping information for a tracking area neighbouring the registration area (e.g. TA3). The group mapping information maps TA3 to one or more groups, the one or more groups comprising a list of network slices that are non-uniformly supported in TA3.

The second message may also comprise further group mapping information for TA3 (i.e. a TA neighbouring the registration area). The further group mapping information comprises a further group. The further group comprising a list of network slices that are uniformly supported in the TA3. The information about the uniformly supported network slices may be useful for the UE because the UE is unaware of uniform support of slices in an TA that does not belong to the UE's RA.

As an example only to aid understanding, the 5GC may provide to the user equipment as part of the second message:
TA1: group 1 (slices 3, 4)
TA1: group 2 (slice 5)
TA1: group 3 (slices 4, 5, 6)
TA1: group 4 (slices 6, 7)
   In the full RA: allowed network slices supported in all cells of the RA: slices 1, 2

This second message indicates that there are four different groups allocated for TA1. Furthermore, network slices 1 and 2 are uniformly supported throughout the RA. In this way, any cells in TA1 which support group 1 support slices 1 and 2 (uniformly), as well as slices 3 and 4. Any cells in TA1 which support group 2 support slices 1, 2 and 5. Any cells in TA1 which support group 3 support slices 1, 2, 4, 5, and 6. Any cells in TA1 which support group 4 support slices 1, 2, 6 and 7. It should be understood that four different groups is an example only. In other examples, there may be more or less than four groups per TA.

As there are four groups in TA1, this may efficiently be encoded with 2 bits as:
Group 1 of TA1=00
Group 2 of TA1=01
Group 3 of TA1=10
Group 4 of TA1=11

Similar information may be provided in the second message for other TAs of the RA (e.g. TA2). Similar information may also be provided in the second message for a tracking area that neighbours TA1 (e.g. TA3).

Using the group mapping information with the cell mapping information, the UE can determine whether there is a cell that neighbours the current cell which supports a non-uniformly supported network slice or combination of network slices. In response to determining that the neighbour cell supports the non-uniformly supported network slice or combination of network slices, the UE may select the neighbour cell that during a cell selection or cell reselection process.

In some examples, S503 followed by S504 may take place (in time) before S501. The steps performed by the 5GC in the above example, may be performed by an AMF of the 5GC. In other examples, other network functions of the 5GC may perform the steps.

FIG. 6 shows an example signalling diagram between a user equipment and network entities. In FIG. 6, there are communications between a UE, a first and second base station (gNB1, gNB2), and a 5G core network (5GC). In this example, the UE has been allocated to both TA1 and TA2, which are part of the same RA (UE RA=TA1, TA2). In this example, the UE may be currently camping on gNB1 (cell 1). The example shown in FIG. 6 is similar to FIG. 5, other that the UE receives the group mapping information per TA in a radio resource control message instead of an NAS register accept message.

In the example of FIG. 6, the UE indicates its support for the group mapping information per tracking area mechanism. This is referred to as a ‘group reading capability’. The UE provides this indication of support to the 5GC in a first message.

The first message may be a non-access stratum (NAS) register request. When the 5GC detects this indication from the UE, the 5GC sends a second message to the serving gNB. The second message comprises the allowed NSSAI (uniformly supported network slices) and additionally for one or more i) TAs of the RA of the UE and ii) the TAs neighbouring the RA: a group mapping information for each TA. The second message may be next generation application protocol (NGAP) initial context setup request message. The group mapping information for each TA may have been received, at the 5GC, from one or more gNB(s). Alternatively, the group mapping information may have been configured by operation and maintenance (O&M) at the 5GC. For a tracking area, each group indicates a unique combination of network slices that are supported by one or more of the cells of the tracking area. For example, there may be four different groups for a particular TA because the cells of the TA support 4 different combinations of non-uniformly supported network slices.

In the second message, the 5GC sends to the serving gNB:
For each TA of the RA: one or more groups (wherein each group is list of S-NSSAIs non uniformly supported in the TA)
For each TA neighbouring the RA: one or more groups (wherein each group is a list of S-NSSAIs non-uniformly supported in the TA)+one further group of S-NSSAIs that are uniformly supported in the TA
   For the TAs that neighbour the RA of the UE, the further group is provided because the UE does not know which network slices are uniformly supported in a TA that does not belong to said UE's RA.

It should be understood, that in some examples, not all of the TAs in the RA will provide the group mapping information. In these examples, a subset of the TAs in the RA will provide group mapping information.

Whenever the UE is sent to RRC idle or RRC_inactive, the serving gNB will include the group mapping information in the RRC message. In an example, the RRC message is an RRC release message. If the UE undergoes a handover from gNB1 to gNB2 (while still connected) then the group mapping information may be provided to the new serving gNB2 as part of the UE context.

Additionally, one or more gNBs provide a cell broadcast. The cell broadcast provides cell mapping information for a current tracking area and/or a neighbour tracking area. The cell mapping information maps a list of cells to the one or more groups. The cells may be identified by a physical cell identity (PCI). The mapping shows which cells support the combination of non-uniformly supported network slices, as identified in each group.

In the cell broadcast, the gNB sends to the UE:
per current TA, per group (list of neighbour cell PCIs that support the group))
per neighbour TA, per group (list of neighbour cell PCIs that support the group)

In some examples, a gNB may also provide the information on a per frequency basis. This may occur, if for example, some neighbour cells are transmitting on a different frequency compared to current cell.
(per frequency, for current TA+neighbour TA) (per group (list of neighbour PCIs that support the group))

When the UE has received the signalling, the UE may use the group mapping information for all TAs, and the cell mapping information broadcast in its current cell, to identify which are the network slices that are supported by each neighbour cell identified by a PCI. The UE can use this to influence its cell selection/cell re-selection process.

In S601, a first base station (gNB1) provides a cell broadcast. The gNB1 may represent a first cell (cell 1), which is part of a first TA (TA1). The cell broadcast may comprise cell mapping information for TA1. The cell mapping information maps a list of cells of TA1 to one or more groups. Each group comprises a list of network slices that are non-uniformly supported in TA1.

The cell broadcast may also comprise cell mapping information for a TA that neighbours TA1. For example, TA2 may neighbour TA1. The cell mapping information maps a list of cells of TA2 to one or more groups. Each group comprises a list of network slices that are non-uniformly supported in TA2.

As an example only to aid understanding, gNB1 may provide to the user equipment (broadcast from cell 1):
TA1: [Group 1 (supported by cells 2, 3), Group 2 (supported by cells 5,7)]
TA2: [Group 1 (supported by cells 14, 15), Group 2 (supported by cells 16, 17)]

This broadcast indicates that cells 2 and 3 support the non-uniformly supported network slices comprised within group 1 of TA1. Furthermore, that cells 5 and 7 support the non-uniformly supported network slices comprised within group 2 of TA1. This broadcast also indicates that cells 14 and 15 support the non-uniformly supported network slices comprised within group 1 of TA2. Furthermore, that cells 16 and 17 support the non-uniformly supported network slices comprised within group 2 of TA2. In the above example, cells 1-9 may be part of TA1, while cells 10-19 may be part of TA2. It should be understood, that as the groups are uniquely associated with each TA, the network slices supported in group 1 of TA1 and group 1 of TA2 may be different.

At S602, a second base station (gNB2) provides a cell broadcast. The gNB2 may represent a second cell (cell 11), which is part of a second TA (TA2). The cell broadcast may comprise cell mapping information for TA2. The cell mapping information maps a list of cells of TA2 to one or more groups. Each group comprises a list of network slices that are non-uniformly supported in TA2.

The cell broadcast may also comprise cell mapping information for a TA that neighbours TA2. For example, TA1 neighbour TA2. The cell mapping information maps a list of cells of TA1 to one or more groups. Each group comprises a list of network slices that are non-uniformly supported in TA1.

In some examples, at S602, the gNB2 provide the cell mapping information on a per frequency basis. This may occur, if for example, some neighbour cells are transmitting on a different frequency compared to current cell.

At S603, the 5GC sends a message to serving gNB1. The message may be a next generation application protocol (NGAP) initial context setup request message. In other examples, other suitable messages are used.

The message may comprise group mapping information for a TA1 of the RA. The group mapping information maps TA1 to one or more groups, the one or more groups comprising a list of network slices that are non-uniformly supported in TA1.

The message may also comprise group mapping information for a tracking area neighbouring the registration area (e.g. TA3). The group mapping information maps TA3 to one or more groups, the one or more groups comprising a list of network slices that are non-uniformly supported in TA3.

The message may also comprise further group mapping information for TA3 (i.e. a TA neighbouring the registration area). The further group mapping information comprises a further group. The further group comprising a list of network slices that are uniformly supported in the TA3. The information about the uniformly supported network slices may be useful for the UE because the UE is unaware of uniform support of slices in an TA that does not belong to the UE's RA.

As an example only to aid understanding, the 5GC may provide to the user equipment as part of the second message:
TA1: group 1 (slices 3, 4)
TA1: group 2 (slice 5)
TA1: group 3 (slices 4, 5, 6)
TA1: group 4 (slices 6, 7) In the full RA: allowed network slices supported in all cells of the RA: slices 1, 2

This message indicates that there are four different groups allocated for TA1. Furthermore, network slices 1 and 2 are uniformly supported throughout the RA. In this way, any cells in TA1 which support group 1 support slices 1 and 2 (uniformly), as well as slices 3 and 4. Any cells in TA1 which support group 2 support slices 1, 2 and 5. Any cells in TA1 which support group 3 support slices 1, 2, 4, 5, and 6. Any cells in TA1 which support group 4 support slices 1, 2, 6 and 7. It should be understood that four different groups is an example only. In other examples, there may be more or less than four groups per TA.

As there are four groups in TA1, this may efficiently be encoded with 2 bits as:
Group 1 of TA1=00
Group 2 of TA1=01
Group 3 of TA1=10
Group 4 of TA1=11

Similar information may be provided in the message for other TAs of the RA (e.g. TA2). Similar information may also be provided in the message for a tracking area that neighbours TA1 (e.g. TA3).

At S604, the serving gNB1 stores the group mapping information in a UE context.

At S605, there is a proposed handover of the UE from gNB1 to gNB2. gNB1 sends a handover request message to gNB2. The handover request message may comprise the UE context, wherein the UE context comprises the group mapping information.

At S606, the serving gNB2 sends an RRC release message to the UE, as the UE goes idle. The RRC release message comprises the group mapping information. In other examples, if the handover did not occur from gNB1 to gNB2, then gNB1 will send the group mapping information to the UE in an RRC release message when UE goes to idle.

Using (based on) the group mapping information with the cell mapping information, the UE can determine whether there is a cell that neighbours the current cell which supports a non-uniformly supported network slice or combination of network slices. In response to determining that the neighbour cell supports the non-uniformly supported network slice or combination of network slices, the UE may select the neighbour cell that during a cell selection or cell reselection process.

In some examples, S603 to S606 may take place (in time) before S601. The steps performed by the 5GC in the above example, may be performed by an AMF of the 5GC. In other examples, other network functions of the 5GC may perform the steps.

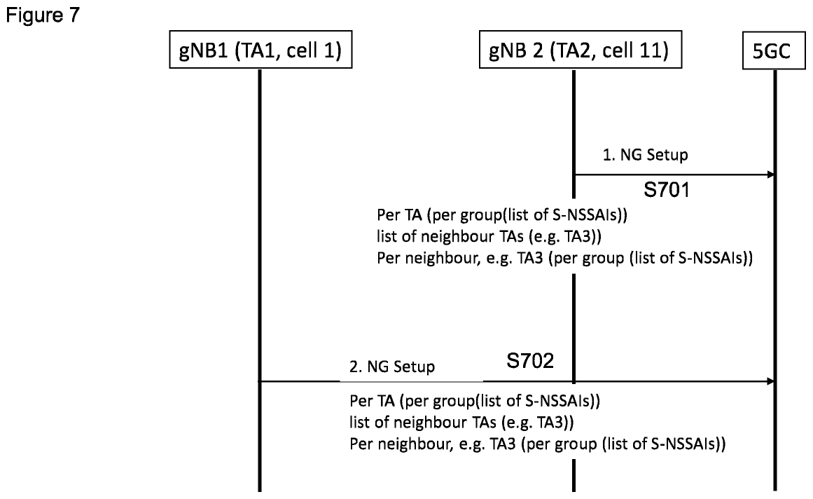

FIG. 7 shows an example signalling diagram between network entities. In FIG. 7, there are communications between a first and second base station (gNB1, gNB2), and a 5G core network (5GC).

In current specifications, gNBs will provide, to the 5GC, a list of supported network slices per tracking area of the gNB. As per FIG. 7, gNBs will additionally provide group mapping information per tracking area that the gNB is part of.

The group mapping information per TA may comprise:
For a TA of the gNB: one or more groups (each group comprising a list of network slices that are not available (i.e. non-uniformly supported) in all cells of the TA
For a neighbour TA (neighbouring a TA of the gNB): one group of network slices that are supported in full TA+one or more groups (each group comprising a list of network slices that are not available (i.e. non-uniformly supported) in all cells of the TA.

At S701, gNB2 provides a first message to the 5GC. The first message may comprise group mapping information. The group mapping information may be provided per tracking area.

The first message may comprise group mapping information for one or more of the tracking areas that gNB2 is part of. For one of these TAs, the group mapping information may comprise one or more groups. The group mapping information maps the TA to the one or more groups. The one or more groups each comprise a list of network slices that are non-uniformly supported in the TA.

The first message may also comprise group mapping information for one or more tracking areas that neighbour a TA that the gNB2 is part of. For one of these neighbour TAs, the group mapping information may comprise one or more groups. The group mapping information maps the neighbour TA to the one or more groups. The one or more groups each comprise a list of network slices that are non-uniformly supported in the neighbour TA. For each neighbour TA, the first message may also comprise a list of network slices uniformly supported in the neighbour TA.

The first message may be a next generation (NG) setup request message. In other examples, the first message may be another suitable message type.

At S702, gNB1 provides a second message to the 5GC. The second message may comprise group mapping information. The group mapping information may be provided per tracking area.

The second message may comprise group mapping information for one or more of the tracking areas that gNB1 is part of. For one of these TAs, the group mapping information may comprise one or more groups. The group mapping information maps the TA to the one or more groups. The one or more groups each comprise a list of network slices that are non-uniformly supported in the TA.

The second message may also comprise group mapping information for one or more tracking areas that neighbour a TA that the gNB1 is part of. For one of these neighbour TAs, the group mapping information may comprise one or more groups. The group mapping information maps the neighbour TA to the one or more groups. The one or more groups each comprise a list of network slices that are non-uniformly supported in the neighbour TA. For each neighbour TA, the second message may also comprise a list of network slices uniformly supported in the neighbour TA.

The second message may be a next generation (NG) setup request message. In other examples, the second message may be another suitable message type.

The information received by the 5GC in the first and second message may be used by the 5GC as seen in the signalling diagrams of FIGS. 5 and 6. The 5GC may consolidate the received information from gNB1 and gNB2 to configure the messages of S504 and/or S603. In some examples, it may be an AMF of the 5GC that performs said consolidation.

In an example, the group mapping information comprises at least one frequency associated with a group.

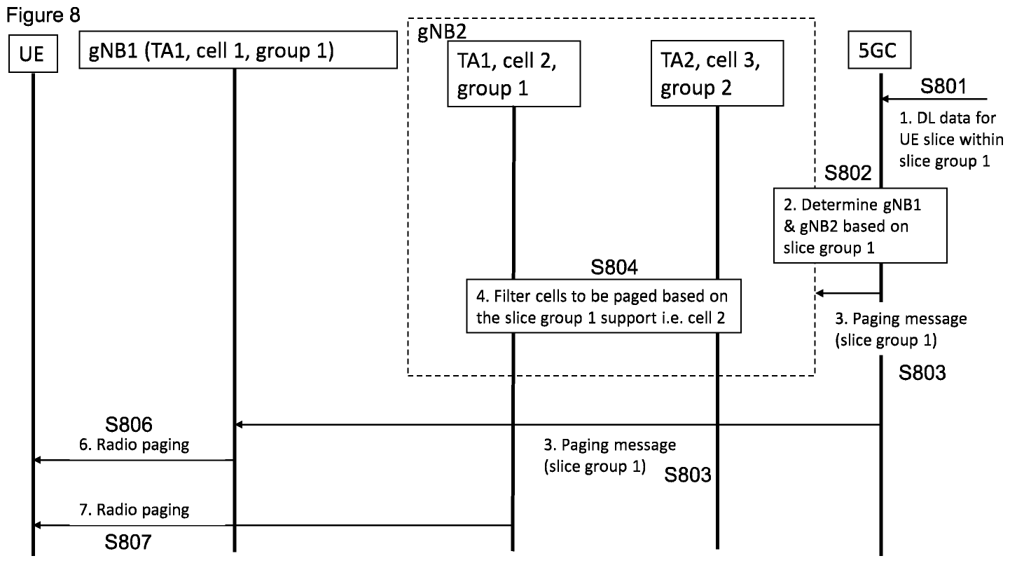

FIG. 8 shows an example signalling diagram between network entities. In FIG. 8, there are communications between a UE, a first and a second base station (gNB1, gNB2), and a 5G core network (5GC).

In FIG. 8, gNB1 is part of TA1. gNB1 serves cell 1. Cell 1 is part of network slice group 1. gNB2 serves two cells (cell 2 and cell 3). Cell 2 is in TA1. Cell 2 is part of network slice group 1. Cell 3 is part of slice group 2.

The group mapping information per tracking area that is described above alongside FIGS. 5 to 7, can also be used when paging idle-state UEs. For non-uniformly supported network slices, the 5GC may determine and page one or more gNBs that have indicated a matching group, i.e., gNBs with the non-uniform network slice support. In some examples, the 5GC can include the group in a paging message being sent to a gNB. Once the paging message with the group is received, indicating the non-uniform slice support, gNBs perform RAN paging only in the cells where a target network slice group is supported.

In some examples, a paging priority can also be mapped to a group. The group will still comprise a list of non-uniformly supported network slices, but will also comprise or correspond to a paging priority. gNBs can factor in the paging priority (from the group) inside the paging message to determine which cells are to be paged on the radio interface.

In some examples, in case where a network slice is common between a group and uniform slice support in a TA (e.g., S-NSSAI 1 is homogeneous in TA1 and also part of group 1 of TA1), a paging priority can be set such that the UE is first paged in the group. If there is no response to the first page, then the gNB can proceed with paging the full TA. When the full TA is paged, the cells/gNBs which were paged initially may be excluded from the second page.

At S801, the 5GC receives downlink data for a UE using a slice that is comprised within group 1 of TA1. Group 1 comprising a list of a non-uniformly supported network slices.

At S802, the 5GC determines supporting base stations. In this example, gNB1 and gNB2 both serve cells that support group 1 for TA1. 5GC determines that gNB1 and gNB2 support the group 1 for TA1.

At S803, in response to determining support, the 5GC provides a paging message to both gNB1 and gN2. Each paging message comprises group 1 of TA1. At S804, gNB2 filters which cells, that are served by gNB2, are to be paged. gNB2 filters the cells using the group (group 1) comprised within the received paging message. In this example, cell 2 supports group 1 for TA1, while cell 3 does not support group 1 for TA1. Thus, in this example, gNB2 filters cell 3 out.

At S806, gNB1 pages the UE.

At S807, cell 2 of gNB2 pages the UE.

The steps performed by the 5GC in the above example, may be performed by an AMF of the 5GC. In other examples, other network functions of the 5GC may perform the steps.

In some other examples, a paging priority may also be comprised within the group. In some examples, the paging priority may be implicitly comprised within the group. The group with the paging priority is then included in the paging message. The paging priority can then be used by the gNBs to prioritise across pagings.

As described above, in the examples of FIGS. 5 to 8, the group mapping information comprising one or more groups is provided for each TA. The groups that are configured are uniquely defined for each TA. An advantage of this is that it makes the number of combinations of network slices non-uniformly supported per TA quite limited. This allows a broadcast of a few groups in a cell with each group having a reduced size. For example, if there are four different groups per TA then this can be transmitted with 2 bits, or if there are nine different groups per TA then this can be transmitted with 3 bits. Thus, one or more examples described above allows a UE to be informed of which cells support non-uniformly supported network slices in a manner that is efficient in terms of radio resource usage. This makes the mechanism scalable for broadcast across a public land mobile network (PLMN).

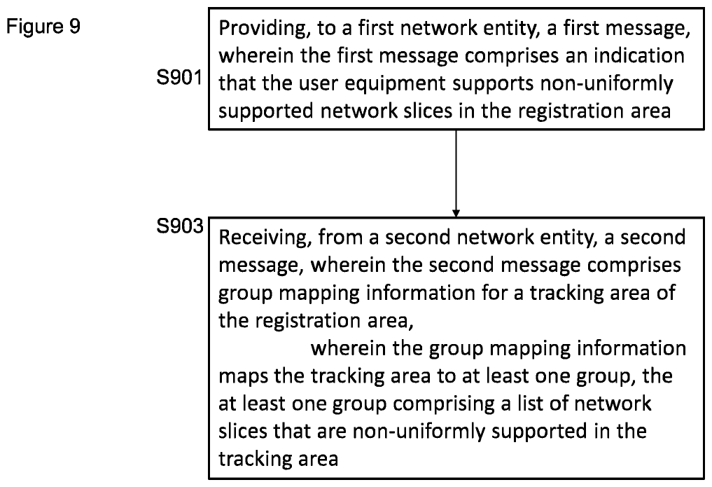

FIG. 9 shows an example method flow performed by an apparatus. In any of the embodiments and examples described in this document the apparatus may be comprised within a user equipment or may be implemented by a user equipment. The apparatus may be comprised within or be implemented by a terminal.

In S901, the method comprises providing, to a first network entity, a first message, wherein the first message comprises an indication that the user equipment supports non-uniformly supported network slices in the registration area.

In S903, the method comprises receiving, from a second network entity, a second message, wherein the second message comprises group mapping information for a tracking area of the registration area, wherein the group mapping information maps the tracking area to at least one group, the at least one group comprising a list of network slices that are non-uniformly supported in the tracking area.

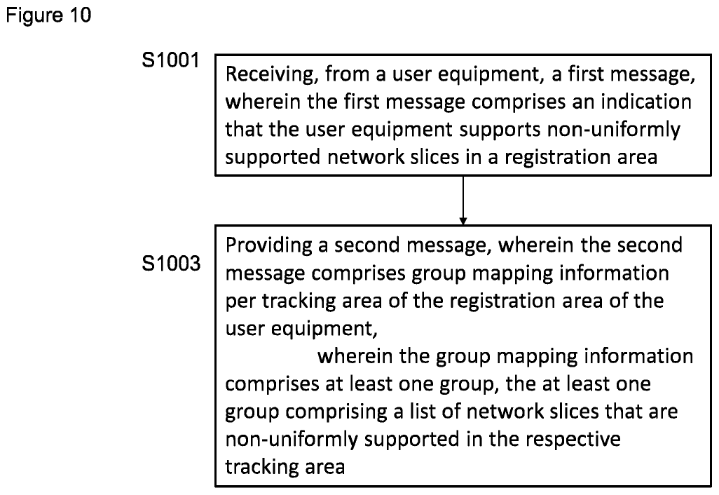

FIG. 10 shows an example method flow performed by an apparatus. The apparatus may be comprised within a cellular system. In an example, the apparatus may be comprised within an access management function of the cellular system.

In S1001, the method comprises receiving, from a user equipment, a first message, wherein the first message comprises an indication that the user equipment supports non-uniformly supported network slices in a registration area.

In S1003, the method comprises providing a second message, wherein the second message comprises group mapping information per tracking area of the registration area of the user equipment, wherein the group mapping information comprises at least one group, the at least one group comprising a list of network slices that are non-uniformly supported in the respective tracking area.

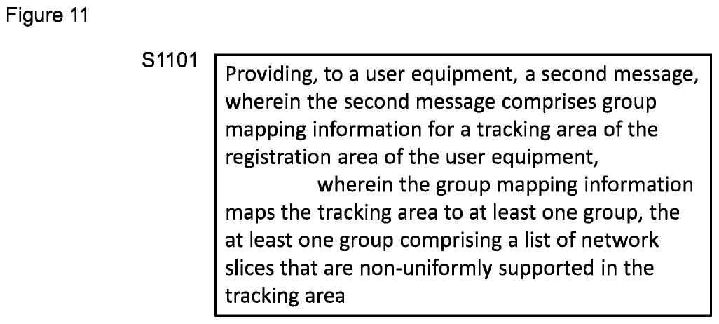

FIG. 11 shows an example method flow performed by an apparatus. The apparatus may be comprised within a network entity. In an example, the apparatus may be comprised within a base station. For example, a gNodeB. In an example, the apparatus may be comprised within a network access node.

In S1101, the method comprises providing, to a user equipment, a second message, wherein the second message comprises group mapping information for a tracking area of the registration area of the user equipment, wherein the group mapping information maps the tracking area to at least one group, the at least one group comprising a list of network slices that are non-uniformly supported in the tracking area.

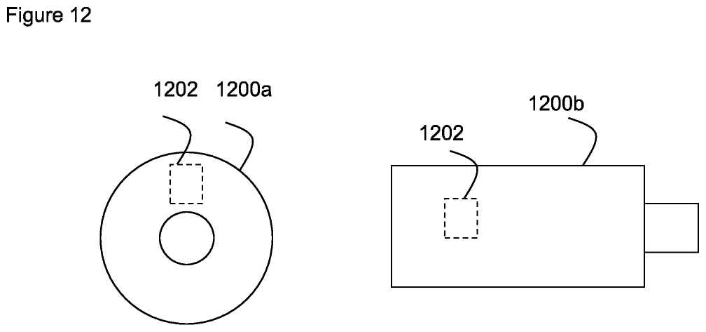

FIG. 12 shows a schematic representation of non-volatile memory media 1200a (e.g. computer disc (CD) or digital versatile disc (DVD)) and 1200b (e.g. universal serial bus (USB) memory stick) storing instructions and/or parameters 1202 which when executed by a processor allow the processor to perform one or more of the steps of the methods of FIG. 9, FIG. 10 or FIG. 11.

In should be understood that in the above signalling diagrams of FIGS. 5 to 8, there may be variations of the steps that take place. In some examples, some of the steps shown may be omitted. In some examples, some of steps may take place in a different order than shown in the Figures.

It is noted that while the above describes example embodiments, there are several variations and modifications which may be made to the disclosed solution without departing from the scope of the present invention.

The examples may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

Alternatively, or additionally some examples may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory (ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1-33. (canceled)

34. An apparatus comprising at least one processor, and memory storing instructions which, when executed by the at least one processor, cause the apparatus at least to:
provide, to a first network entity, a first message comprising an indication that the apparatus supports non-uniformly supported network slices in a registration area;
receive, from a second network entity, a second message comprising group mapping information for a tracking area of the registration area,
wherein the apparatus is operable to be registered in a registration area,
wherein the group mapping information maps the tracking area to at least one group, the at least one group comprising a list of network slices that are non-uniformly supported in the tracking area.

35. The apparatus according to claim 34, wherein the second message comprises group mapping information for a tracking area neighbouring the registration area,
wherein the group mapping information maps the tracking area to at least one group, the at least one group comprising a list of network slices that are non-uniformly supported in the tracking area.

36. The apparatus according to claim 35, wherein the second message comprises further group mapping information for the tracking area neighbouring the registration area,
wherein the further group mapping information comprises a further group, the further group comprising a list of network slices that are uniformly supported in the respective tracking area that is neighbouring the registration area.

37. The apparatus according to claim 36, wherein the group mapping information and/or the further group mapping information comprises at least one frequency associated with at least one group.

38. The apparatus according to claim 34, wherein the instructions, which, when executed by the at least one processor, further cause the apparatus at least to:
receive, from at least one base station serving at least one cell, a broadcast message comprising cell mapping information for: a current tracking area of the at least one cell,
wherein the cell mapping information maps a list of cells of the tracking area to the at least one group.

39. The apparatus according to claim 38, wherein the broadcast message comprises cell mapping information for a tracking area that neighbours the current tracking area of the at least one cell,
wherein the cell mapping information maps a list of cells of the tracking area that neighbours the current tracking area to the at least one group.

40. The apparatus of according to claim 38, wherein the list of cells of the tracking area that neighbours the current tracking area are neighbour cells of a current cell where the apparatus is camping.

41. The apparatus according to claim 38, wherein the instructions, which, when executed by the at least one processor, further cause the apparatus at least to:
determine whether there is at least one cell that neighbours the current cell which supports at least one non-uniformly supported network slice using the received group mapping information and cell mapping information

42. The apparatus according to claim 41, wherein the instructions, which, when executed by the at least one processor, further cause the apparatus at least to:
in response to determining that the at least one cell that neighbours the current cell supports at least one non-uniformly supported network slice, select the at least one cell that neighbours the current cell during a cell selection or cell reselection process.

43. The apparatus according to claim 34, wherein the at least one group comprises at least two groups, each group of the at least two groups comprising a list of network slices that are non-uniformly supported in the tracking area.

44. An apparatus comprising at least one processor, and memory storing instructions which, when executed by the at least one processor, cause the apparatus at least to:
receive, from a user equipment, a first message, wherein the first message comprises an indication that the user equipment supports non-uniformly supported network slices in a registration area;
provide a second message, wherein the second message comprises group mapping information per tracking area of the registration area of the user equipment,
wherein the group mapping information comprises at least one group, the at least one group comprising a list of network slices that are non-uniformly supported in the respective tracking area.

45. The apparatus according to claim 44, wherein the second message is provided to one of: the user equipment, and a base station.

46. The apparatus according to claim 44, wherein the second message comprises group mapping information for a tracking area neighbouring the registration area,
wherein the group mapping information maps the tracking area to at least one group, the at least one group comprising a list of network slices that are non-uniformly supported in the tracking area.

47. The apparatus according to claim 46, wherein the second message comprises further group mapping information for the tracking area neighbouring the registration area,
wherein the further group mapping information comprises a further group, the further group comprising a list of network slices that are uniformly supported in the respective tracking area that is neighbouring the registration area.

48. The apparatus according to claim 44, wherein the second message is a non-access stratum registration response message.

49. An apparatus comprising at least one processor, and memory storing instructions which, when executed by the at least one processor, cause the apparatus at least to:
serve at least one cell;
provide, to a user equipment, a second message, wherein the second message comprises group mapping information for a tracking area of a registration area of the user equipment,
wherein the group mapping information maps the tracking area to at least one group, the at least one group comprising a list of network slices that are non-uniformly supported in the tracking area.

50. The apparatus according to claim 49, wherein the second message comprises group mapping information for a tracking area neighbouring the registration area of the user equipment,
wherein the group mapping information maps the tracking area to at least one group, the at least one group comprising a list of network slices that are non-uniformly supported in the tracking area.

51. The apparatus according to claim 49, wherein the second message comprises further group mapping information for the tracking area neighbouring the registration area,
wherein the further group mapping information comprises a further group, the further group comprising a list of network slices that are uniformly supported in the respective tracking area that is neighbouring the registration area.

52. The apparatus according to claim 49, wherein the means are configured to perform:
providing, to the user equipment, a broadcast message comprising cell mapping information for: a current tracking area of the at least one cell,
wherein the cell mapping information maps a list of cells of the tracking area to the at least one group.

53. The apparatus according to claim 52, wherein the broadcast message comprises cell mapping information for a tracking area that neighbours the current tracking area of the at least one cell,
wherein the cell mapping information maps a list of cells of the tracking area that neighbours the current tracking area to the at least one group.
